(19) United States
(12) Patent Application Publication
(10) Pub. No.: US 2026/0048551 A1
(43) Pub. Date: Feb. 19, 2026

(54) ADAPTIVE 3D PRINTING WITH COHESION ANALYSIS

(71) Applicant: INTERNATIONAL BUSINESS MACHINES CORPORATION, Armonk, NY (US)

(72) Inventors: Martin G. Keen, Cary, NC (US); Tushar Agrawal, West Fargo, ND (US); Carolina Garcia Delgado, Zapopan (MX); Sarbajit Kumar Rakshit, Kolkata (IN)

(21) Appl. No.: 18/801,954

(22) Filed: Aug. 13, 2024

(51) Int. Cl. B29C 64/393; B33Y 50/02

(52) U.S. Cl. CPC B29C 64/393; B33Y 50/02

(57) ABSTRACT

Methods and systems for adaptive printing include predicting a cohesion failure between layers of an in-progress print using a trained predictive model. The print is paused using a print control of a three-dimensional (3D) printer and a print parameter is modified to improve cohesion of a next layer. The print is resumed using the modified print parameter.

### BACKGROUND

The present invention generally relates to three-dimensional (3D) printing and, more particularly, to monitoring print progress.

3D printing is a technique whereby computer-designed shapes can be rendered with extrudable materials. For example, a 3D printer may have a movable head that melts plastic or otherwise extrudes a material in a predetermined pattern, building up the shape layer-by-layer. 3D printing can be used to create shapes that would be difficult or impossible to make by conventional methods.

However, the printing process can be susceptible to environmental and mechanical variations. For example, some materials need to be applied within specific environmental parameters. If these environmental parameters are not met, the print may fail. An example of such a failure is a cohesion failure, where the extruded material of a given layer fails to adhere correctly to the previously deposited layer.

### SUMMARY

A method for adaptive printing includes predicting a cohesion failure between layers of an in-progress print using a trained predictive model. The print is paused using a print control of a three-dimensional (3D) printer and a print parameter is modified to improve cohesion of a next layer. The print is resumed using the modified print parameter.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a three-dimensional (3D) printer that can predict when a cohesion failure is imminent and automatically change its operational parameters to improve cohesion, in accordance with an embodiment of the present invention;

FIG. 2 is a block/flow diagram of a method for training and using a predictive model to predict and prevent cohesion failures in a 3D print, in accordance with an embodiment of the present invention;

FIG. 3 is a block diagram of a computing environment that can be used to perform adaptive 3D printing, in accordance with an embodiment of the present invention;

FIG. 4 is a diagram of an exemplary neural network architecture that can be used to implement part of a predictive model for predicting cohesion failures in a 3D print, in accordance with an embodiment of the present invention; and

FIG. 5 is a diagram of an exemplary deep neural network architecture that can be used to implement part of a predictive model for predicting cohesion failures in a 3D print, in accordance with an embodiment of the present invention.

### DETAILED DESCRIPTION

To prevent three-dimensional (3D) printing failures, print conditions may be monitored by one or more sensors. The information gathered by the sensor(s) is used to predict whether an upcoming layer will achieve a predetermined level of cohesive strength in adhering to the previously laid layer. If a cohesion failure is predicted, then print and/or environmental parameters may be adjusted to ensure that the next layer of printing is performed successfully.

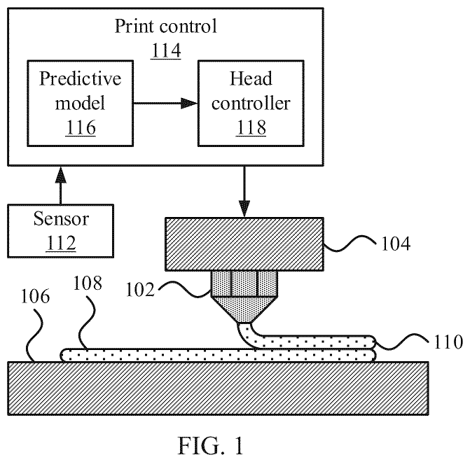

Referring now to FIG. 1, an exemplary 3D printing system is shown. A print head 102 is attached to a gantry 104 or other fixture that moves laterally over a print bed 106. As the print head moves, it extrudes a print material, which is deposited on the print bed 106. After a full layer 108 is deposited, the gantry 104 moves the print head 102 vertically and a next layer 110 is deposited on top of the previous layer 108. The print head 102 is moved in accordance with a 3D design and extrudes a filament of the print material to match the 3D design. This view of a 3D printing system is intended to be purely exemplary and should not be regarded as limiting—other types of 3D printing are contemplated and fall within the scope of the present principles.

During printing of a next layer 110, the conditions may not be appropriate for ensuring a strongly cohesive deposition onto the previous layer 108. Cohesive force refers to the attractive forces that hold together the particles or molecules within a substance or material. The cohesive force enables the material to maintain its structural integrity, preventing it from falling apart. Because 3D shapes are built layer-by-layer, adequate cohesive forces are needed to ensure that each next layer 110 adheres firmly to the previous layer 108. Insufficient cohesion between layers can result in delamination or weak bonding, leading to structural instability in the final object. Cohesive forces are responsible for maintaining the shape of the 3D-printed object during and after the printing process. Without strong cohesive forces, the material may sag or deform, leading to inaccuracies in the final object.

Poor cohesion between layers can result from a variety of factors. Causes may include inadequate adhesion between the first layer and the print bed 106. If the initial layer does not adhere well, subsequent layers may not be bound effectively, leading to weak inter-layer cohesion. Factors that affect bed adhesion include bed leveling, surface preparation, and temperature settings.

Print temperature may also affect cohesion. For example, each printing material has a range of effective extrusion temperatures. If the print temperature is below this range, the material may not melt sufficiently, resulting in poor cohesion between layers. Print temperatures that are above the effective range may cause over-melting, which can also impair cohesion. Low-quality or impure printing material may include contaminants or inconsistencies that affect layer bonding.

Cooling fans may be used to quickly cool down the previous layer 108 before the next layer 110 is printed. If the cooling fan operates too aggressively, the previous layer 108 may cool too much, resulting in poor cohesion with the next layer 110. Environmental factors, such as temperature and humidity, can also affect layer cohesion.

High print speeds and rapid acceleration can introduce mechanical stresses and vibration that hinder layer-to-layer bonding. Layer height and nozzle size can similarly cause mechanical defects, as thicker layers may not bond properly. The orientation of the object on the print bed 106 and the use of support structures can also affect adhesion.

During the printing process, one or more sensors 112 may collect information about the state of the print. The sensors 112 may include a video camera as well as sensors that collect time-series information relating to specific parameters relating to the print and/or the environment. Such sensors may include thermometers, hygrometers, vibration sensors, and sensors integral to the 3D printing system that report print settings. The information from the sensors 112 is analyzed using by print control 114 which includes a predictive model 116. The predictive model 116 may be implemented as a machine learning system to predict whether the next layer 110 will achieve a threshold level of cohesive strength in its bond to the previous layer 108. If not, the print may be paused using head controller 118 and one or more parameters of the print may be changed, so that the next layer 110 may be formed with sufficient cohesion. The print may then be resumed by head controller 118.

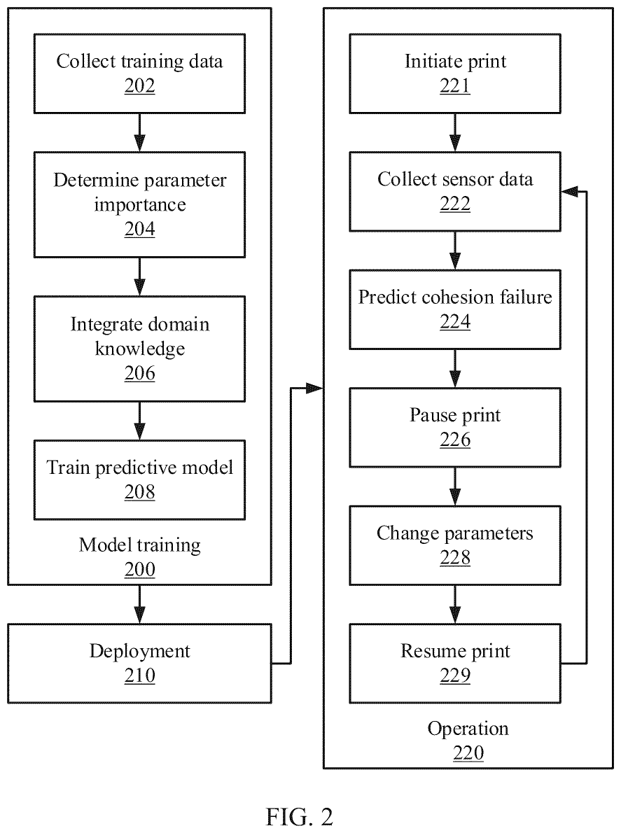

Referring now to FIG. 2, an adaptive 3D printing method is shown. The method includes model training 200, deployment 210, and operation 220. It should be understood that model training 200 may be performed by the same entity as the operation 220, or may be performed by separate entities. When different entities perform these steps, the deployment 210 may transfer parameters of a trained predictive model to a site where the 3D printing will occur. When the same entity performs both, the deployment 210 may be omitted or may be simplified to copying the predictive model to operational memory of a control system.

The model training 200 begins by collecting 202 historical training data from past 3D printing processes. This data may include information relating to various sensors and camera feeds and may further include qualitative information such as an indicator of whether the print was successful or not. If a given print failed, the training data may further include information that identifies a time when the print lost cohesion, so that relevant sensor data may be flagged. Exemplary training data may include camera feeds, test results, scanning outcomes, sensor feeds, printing speed, temperature, layer thickness, humidity, and material type. Notably the training data should be based on a same, or very similar, 3D printing system as will be used in operation 220. The parameters that lead to strong cohesion may vary substantially between different models of 3D printer, in different environments, and with different print materials.

Block 204 determines parameter importance, identifying the parameters that are most relevant to cohesion. Feature selection may be performed using a gradient boosting machine to quantify the influence of each parameter on cohesive force, observing how parameter adjustments in the training data have affected cohesive outcomes. Correlation analysis and feature importance extraction are used to rank and pinpoint the parameters that affect the cohesive force. In some cases a threshold number of parameters may be selected for prediction. In some cases parameters having importance above a threshold value may be selected.

Block 206 integrates expert domain knowledge to enhance understanding of the effects the selected parameters have on cohesion. This information can impact how cracks form and can be used to improve print quality and cohesive strength. For example, domain knowledge may be considered during parameter analysis to enhance the understanding of how specific print parameters affect cohesion to address potential failure points. Expert domain knowledge may therefore be used to adjust the parameter importance determined by block 204.

Block 208 trains a predictive model using a machine learning system. It is particularly contemplated that a support vector machine may be used, but it should be understood that any appropriate machine learning system may be used, such as a neural network classifier, decision trees, and regression models. The selected parameters for each print example in the training data may be plotted in a multi-dimensional space and a function may be determined that discriminates between parameters associated with cohesion failure and parameters associated with successful prints. This function is used to implement predictions, where new parameter values are used as an input and an output is used as a prediction of whether the print associated with the new parameters will have sufficient cohesion.

In embodiments that employ neural networks to implement the predictive model, a convolutional neural network (CNN) may be used to process image data from cameras and recurrent neural networks (RNNs) may be used to process time-series data from the sensors 112. In some embodiments, the predictive model may further include threshold values defined for each parameter, such that sensor values exceeding any such threshold value may automatically flag a likely cohesion failure. The camera information may help to identify visual indicators of a potential cohesion failure, such as uneven layer deposition or surface defects. The imminent loss of cohesion may furthermore be visible in indicators such as gaps, misalignments, or surface irregularities. These visual cues allow for timely adjustments to the print parameters, preventing failures and ensuring structural integrity in the final product.

During operation 220, a new print is initiated 221 and sensor data is collected 222 relating to the selected parameters. Bock 224 is used to process the new sensor data to determine whether the next layer 110 will suffer a cohesion failure. If so, block 226 pauses the print and block 228 modifies the print parameters to ensure that the next layer 110 will be successful. Block 228 may change settings on the 3D printing system or may change environmental conditions. By correlating historical data with successful and failed prints, specific adjustments can be recommended based on their historical impact on cohesion.

Block 229 then resumes the print. This process may be repeated until the print is completed. In some embodiments, the sensor data may be used to generate a new training example after the print completes, which may be used to update the predictive model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

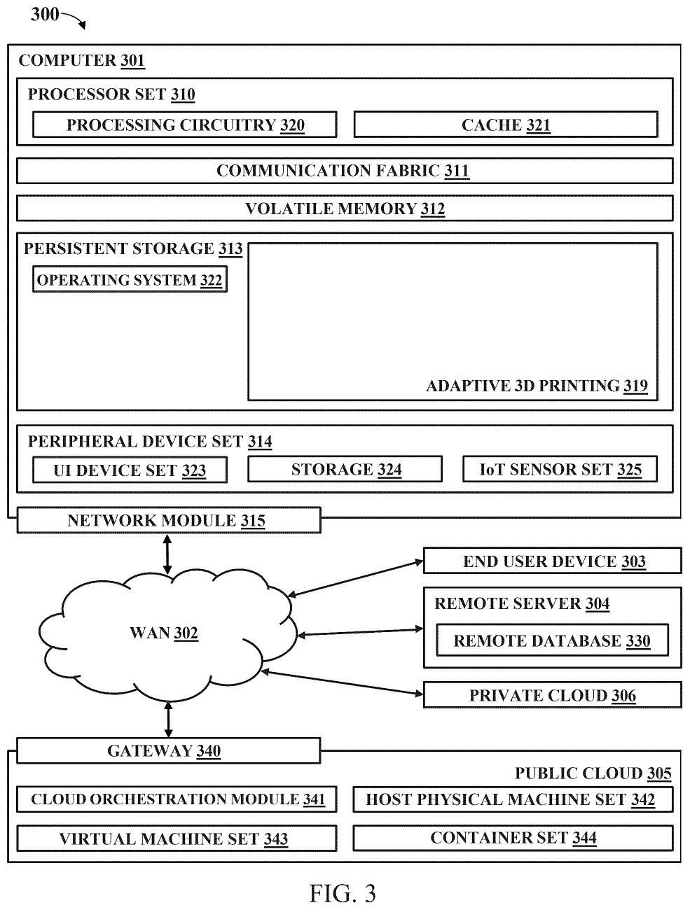

Referring now to FIG. 3, a computing environment 300 is shown that contains an example of an environment for the execution of at least some of the computer code involved in performing the inventive methods, such as adaptive 3D printing 319. In addition to block 319, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 319, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 319 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 319 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315. WAN 302 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

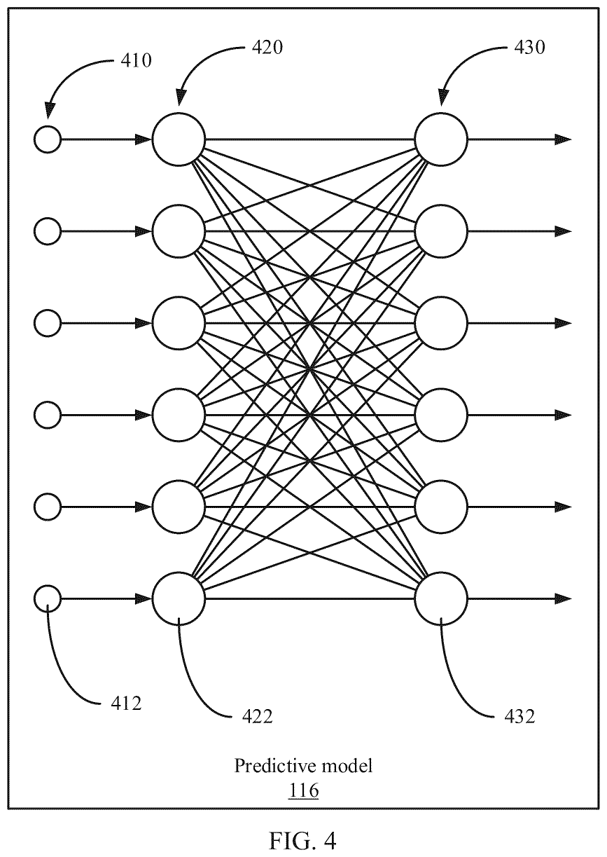

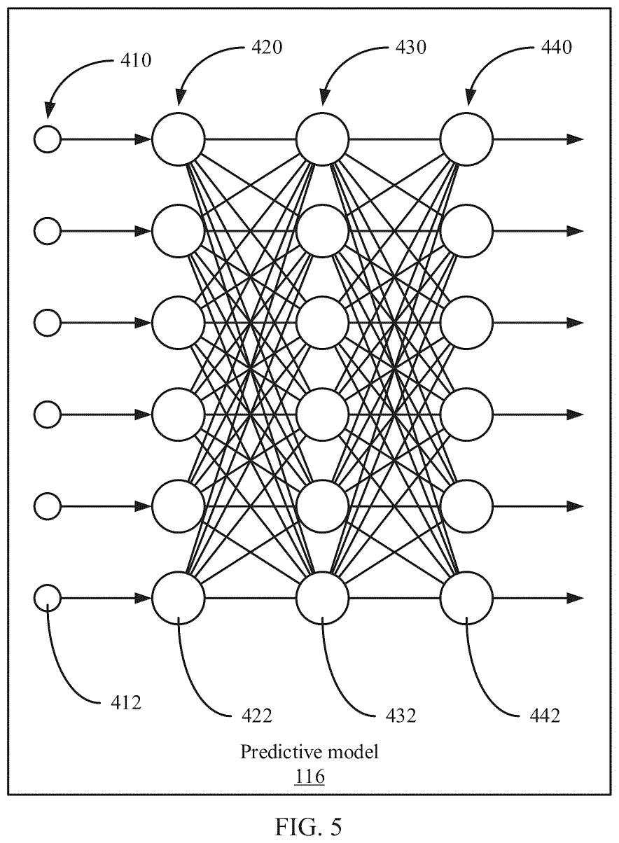

Referring now to FIGS. 4 and 5, exemplary neural network architectures are shown, which may be used to implement parts of the present models, such as predictive model 116. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 420 of source nodes 422, and a single computation layer 430 having one or more computation nodes 432 that also act as output nodes, where there is a single computation node 432 for each possible category into which the input example could be classified. An input layer 420 can have a number of source nodes 422 equal to the number of data values 412 in the input data 410. The data values 412 in the input data 410 can be represented as a column vector. Each computation node 432 in the computation layer 430 generates a linear combination of weighted values from the input data 410 fed into input nodes 420, and applies a non-linear activation function that is differentiable to the sum. The exemplary simple neural network can perform classification on linearly separable examples (e.g., patterns).

A deep neural network, such as a multilayer perceptron, can have an input layer 420 of source nodes 422, one or more computation layer(s) 430 having one or more computation nodes 432, and an output layer 440, where there is a single output node 442 for each possible category into which the input example could be classified. An input layer 420 can have a number of source nodes 422 equal to the number of data values 412 in the input data 410. The computation nodes 432 in the computation layer(s) 430 can also be referred to as hidden layers, because they are between the source nodes 422 and output node(s) 442 and are not directly observed. Each node 432, 442 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of adaptive 3D printing with cohesion analysis (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for adaptive printing, comprising:
predicting a cohesion failure between layers of an in-progress print using a trained predictive model;
pausing the print using a print control of a three-dimensional (3D) printer;
modifying a print parameter to improve cohesion of a next layer; and
resuming the print using the modified print parameter.

2. The method of claim 1, wherein the cohesion failure is predicted between a previously extruded layer of material and a next layer of material.

3. The method of claim 1, further comprising collecting sensor data from one or more sensors, wherein predicting the cohesion failure includes processing the sensor data as an input to the trained predictive model.

4. The method of claim 1, wherein the print parameter is selected from the group consisting of operational parameters of the 3D printer and environmental parameters.

5. The method of claim 1, wherein the trained predictive model is a neural network model that includes a concurrent neural network to process video of the in-progress print and a recurrent neural network to process other sensor information relating to the in-progress print.

6. The method of claim 1, further comprising training the predictive model using collected historical data from a same model of system as the 3D printer.

7. The method of claim 6, wherein training the predictive model includes selecting parameters relevant to cohesion using a gradient boosting machine, and wherein predicting the cohesion failure includes applying sensor data corresponding to the selected parameters as input to the trained predictive model.

8. The method of claim 6, wherein selecting the parameters includes the use of a gradient boosting machine to determine an importance of each of the parameters and ranking the parameters according to the importance.

9. The method of claim 8, wherein selecting the parameters includes adjusting parameter importance according to expert domain knowledge.

10. The method of claim 1, further comprising initiating the print using a 3D design, wherein the print includes moving a print head to extrude that additively builds an object as determined by the 3D design.

11. A computer program product (CPP) for adaptive printing, the computer program product comprising;
a set of one or more computer-readable storage media; and
program instructions, collectively stored in the set of one or more computer storage media, for causing a processor set to perform the following computer operations:
predict a cohesion failure between layers of an in-progress print using a trained predictive model;
pause the print using a print control of a three-dimensional (3D) printer;
modify a print parameter to improve cohesion of a next layer; and
resume the print using the modified print parameter.

12. A computer system (CS) for adaptive printing, the computer system comprising:
a processor set;
a set of one or more computer readable storage media; and
program instructions, collectively stored in the set of one or more storage media, for causing the processor set to perform the following computer operations:
predict a cohesion failure between layers of an in-progress print using a trained predictive model;
pause the print using a print control of a three-dimensional (3D) printer;
modify a print parameter to improve cohesion of a next layer; and
resume the print using the modified print parameter.

13. The system of claim 12, wherein the cohesion failure is predicted between a previously extruded layer of material and a next layer of material.

14. The system of claim 12, further comprising collecting sensor data from one or more sensors, wherein predicting the cohesion failure includes processing the sensor data as an input to the trained predictive model.

15. The system of claim 12, wherein the print parameter is selected from the group consisting of operational parameters of the 3D printer and environmental parameters.

16. The system of claim 12, wherein the trained predictive model is a neural network model that includes a concurrent neural network to process video of the in-progress print and a recurrent neural network to process other sensor information relating to the in-progress print.

17. The system of claim 12, further comprising training the predictive model using collected historical data from a same model of system as the 3D printer.

18. The system of claim 17, wherein training the predictive model includes selecting parameters relevant to cohesion using a gradient boosting machine, and wherein predicting the cohesion failure includes applying sensor data corresponding to the selected parameters as input to the trained predictive model.

19. The system of claim 17, wherein selecting the parameters includes the use of a gradient boosting machine to determine an importance of each of the parameters and ranking the parameters according to the importances.

20. The system of claim 19, wherein selecting the parameters includes adjusting parameter importance according to expert domain knowledge.
